(19) United States
(12) Patent Application Publication
(10) Pub. No.: US 2017/0198238 A1
(43) Pub. Date: Jul. 13, 2017

(54) FABRIC-SOFTENING COMPOSITION COMPRISING AN HEUR THICKENER

(71) Applicant: COATEX, Genay (FR)

(72) Inventors: Yves KENSICHER, Theize (FR); Yves MATTER, Quincieux (FR); Jean-Marc SUAU, Lucenay (FR)

(73) Assignee: COATEX, Genay (FR)

(21) Appl. No.: 15/315,259

(22) PCT Filed: Jul. 16, 2015
(86) PCT No.: PCT/FR2015/051946

§ 371 Date: Nov. 30, 2016

(30) Foreign Application Priority Data
Jul. 18, 2014 (FR) 1456934

(51) Int. Cl. C11D 3/00; C11D 11/00; C11D 3/30; C11D 1/62; C11D 3/37

(52) U.S. Cl. CPC C11D 3/001; C11D 1/62; C11D 3/3726; C11D 3/30; C11D 11/0017

(57) ABSTRACT

The present invention relates to a fabric-softening composition, comprising a cationic fabric softening agent and a thickening polyurethane resulting from the condensation:
a) of at least one compound of formula (I):

R—[(OE)ₘ-(OP)ₙ—(OB)ₚ]—OH (I)
in which:
R is a saturated or unsaturated, linear or branched carbon chain, containing from 17 to 24 carbon atoms,
[(OE)ₘ-(OP)ₙ—(OB)ₚ] represents an alkoxyl chain formed from alternating or statistical alkoxyl units, distributed in blocks, chosen from ethoxyl units OE, propoxyl units OP and butoxyl units OB and
m, n and p represent, independently of each other, 0 or an integer ranging between 1 and 30, the sum of m, n and p being between 20 and 30,
b) of at least one polyol, for example of at least one poly(alkylene glycol) and
c) of at least one polyisocyanate.

The present invention relates to the technical field of fabric-softening compositions. Such fabric-softening compositions are intended, for example, to be used in the rinsing cycle of a washing or laundering process.

In general, softening compositions comprise a softening agent dispersed in an aqueous solution. The use of cationic softening agents is described especially in US 2013/0 065 813, US 2008/0 051 309, US 2004/0 087 470 and U.S. Pat No.6,020,304.

These same documents also describe the use of thickeners, the purpose of which is to facilitate the dosing during use and to satisfy consumers who generally consider that the efficacy of the compositions is associated with their viscosity.

Various categories of thickeners may be used for increasing the viscosities of fabric-softening compositions containing a cationic softening agent. It is possible, for example, to use thickeners of natural origin (for example gelatins, starches, carrageenans), cellulose-based natural thickeners also known as cellulose ethers, of HEC type or of HMHEC type (hydrophobically modified HEC), acrylic thickeners or thickeners bearing urethane bonds.

For example, US 2009/0 124 533 and U.S. Pat. No. 6,020,304 describe the use of thickeners resulting from the condensation of a polyalkylene glycol with an isocyanate compound bearing a hydrophobic chain end. More precisely, US 2009/0 124 533 describes the use of a thickener which is the product of addition of an isocyanate compound with a polyalkylene glycol and which has a saturated and non-ethoxylated C₁₄-C₂₀ alkyl radical at the chain end. U.S. Pat. No. 6,020,304, for its part, describes the use of a thickener bearing urethane bonds with non-ethoxylated linear or branched alkyl or alkenyl C₈-C₂₄ chain ends.

In the context of the present invention, thickening polyurethanes or HEURs result from condensation between 3 constituents, namely: a compound of poly(alkylene glycol) type, a polyisocyanate and a reagent that gives associativity of alkyl, aryl or arylalkyl type formed from a hydrophobic end group.

US 2009/0 291 876 describes an aqueous laundry-treatment composition comprising a cationic softening agent and a viscosity modifier which is a water-soluble linear polymer.

A polymer described as being particularly preferred in said document is a polyurethane bearing at the chain ends a structure formed from 0 to 30 ethoxyl units and from 11 to 25 carbon atoms.

As demonstrated in the experimental section of the present patent application, the inventors realized that, within this broad definition, certain polyurethanes were more particularly efficient for thickening fabric-softening compositions.

One subject of the present invention is a fabric-softening composition, comprising a cationic fabric softening agent and a thickener of HEUR type, which affords better thickening than the thickeners described in the prior art.

Another subject of the present invention is the use of a particular thickening polyurethane for thickening a softening composition containing a cationic fabric softening agent.

### DEFINITIONS

In the description of the present invention, the term “HEUR” is the abbreviation for “Hydrophobically modified Ethoxylated URethane”.

In the description of the present invention, unless otherwise indicated, the percentages expressed represent weight percentages and are expressed relative to the total weight of the reference element. For example, when it is indicated that a polymer comprises 10% of a monomer or of a reagent, it is understood that the polymer comprises 10% by weight of this monomer or of this reagent relative to the total weight of this polymer.

In the description of the present invention, the expression “at least one” denotes one or more compounds (for example: one or more compounds of formula (I), one or more polyols, one or more polyisocyanates), such as a mixture of 2 to 5 compounds.

The term “alkyl” means a linear or branched group CₓH₂ₓ₊₁, where x ranges from 1 to 30, preferably from 10 to 30, or even from 12 to 28.

The term “alkenyl” means a linear or branched group C_{y}H_{2y-1}, where y ranges from 1 to 30, preferably from 10 to 30, or even from 12 to 28.

The term “comprising”, as used in the present description and the present claims, does not exclude other elements. For the purposes of the present invention, the term “formed by” is considered as being an embodiment of the term “comprising”.

For the purposes of the present invention, the limits of the ranges described and claimed are included in the scope of the invention. Thus, when a carbon chain R comprises from 17 to 24 carbon atoms, a carbon chain R comprising 17 carbon atoms, for example, is within the scope of the present invention.

### DETAILED DESCRIPTION OF THE INVENTION

The polyurethanes of the present invention are thickeners that are particularly suitable for fabric-softening compositions.

HEUR Thickener

One subject of the present invention relates to a thickener belonging to the HEUR (Hydrophobically modified Ethoxylated URethane) category. This is a nonionic associative polymer, which thickens fabric-softening compositions.

The thickening polyurethanes or HEURs of the present invention result from the reaction between a compound of poly(alkylene glycol) type, a polyisocyanate and a reagent that gives associativity and that is formed from a hydrophobic end group. In the context of the present invention, the terms “reaction”, “condensation” and “polycondensation” are used equivalently.

More precisely, in the context of the present invention, the thickening polyurethane for fabric-softening compositions results from the condensation:
a) of at least one compound of formula (I):

R—[(OE)ₘ-(OP)ₙ—(OB)ₚ]—OH (I)

in which:

R is a saturated or unsaturated, linear or branched carbon chain, containing from 17 to 24 carbon atoms,

[(OE)ₘ-(OP)ₙ—(OB)ₚ] represents an alkoxyl chain formed from alternating or statistical alkoxyl units, distributed in blocks, chosen from ethoxyl units OE, propoxyl units OP and butoxyl units OB and

m, n and p represent, independently of each other, 0 or an integer ranging between 1 and 30, the sum of m, n and p being between 20 and 30,

b) of at least one polyol, for example of at least one poly(alkylene glycol) and

c) of at least one polyisocyanate.

It is understood that these three constituents a), b) and c) are essential in the constitution of the polyurethanes according to the invention. A person skilled in the art may optionally add other constituents.

These polyurethanes are particularly suitable for thickening fabric-softening formulations moreover comprising a cationic fabric softening agent.

In a detailed manner, the polyurethane according to the present invention comprises as constituent a) at least one compound of formula (I).

The compounds of formula (I) are formed from a hydrophobic part, which is a saturated or unsaturated, linear or branched carbon chain containing from 17 to 24 carbon atoms. They are also formed from a hydrophilic part, which is a polyalkoxyl chain containing between 20 and 30 alkoxyl units.

The polyurethane according to the present invention may comprise several different compounds of formula (I).

The inventors in point of fact realized that, with regard to the teaching of US 2009/0 291 876 which describes the use of a polyurethane bearing at the chain ends a structure formed from 0 to 30 ethoxyl units and from 11 to 25 carbon atoms in an application field identical to that of the present invention, it was possible within this broad definition to select certain polyurethanes that are more particularly efficient for thickening fabric-softening compositions. This selection lies, firstly, in the choice of a narrower length of the hydrophobic chain, namely 17 to 24 carbon atoms. It also lies in the choice of a polyalkoxyl chain length formed from at least 20 alkoxyl units and from not more than 30 alkoxyl units.

According to one embodiment, said thickening polyurethane results from the condensation of at least one compound of formula (I) in which R is a linear or branched carbon chain containing at least one unsaturation, containing from 17 to 24 carbon atoms.

According to another embodiment, said thickening polyurethane results from the condensation of at least one compound of formula (I) in which R is a saturated or unsaturated, linear or branched carbon chain containing from 18 to 23 carbon atoms, for example from 19 to 22 carbon atoms.

In this embodiment, R is a saturated or unsaturated, linear or branched carbon chain containing 18, 19, 20, 21, 22 or 23 carbon atoms.

According to this embodiment, R is preferably a carbon chain bearing an odd number of carbon atoms.

According to another embodiment, said thickening polyurethane results from the condensation of at least one compound of formula (I) in which R is a linear carbon chain bearing one or more unsaturations, containing from 17 to 24 carbon atoms.

According to one embodiment, said thickening polyurethane results from the condensation of at least one compound of formula (I) in which R is a saturated linear or branched carbon chain containing from 17 to 24 carbon atoms.

All these embodiments may, moreover, be combined together.

The compounds of formula (I) moreover comprise a polyalkoxyl chain formed from at least 20 alkoxyl units. Moreover, the compounds of formula (I) comprise a polyalkoxyl chain formed from not more than 30 alkoxyl units.

According to one embodiment of the present invention, in formula (I) below:

R—[(OE)ₘ-(OP)ₙ—(OB)ₚ] (I)
m represents an integer ranging between 1 and 30 (other than 0) and
n and p represent, independently of each other, 0 or an integer ranging between 1 and 29,

the sum of m, n and p being between 20 and 30, for example being equal to 20, 25 or 30.

According to another embodiment of the present invention, in formula (I) above:
m and n represent an integer ranging between 1 and 30 (other than 0) and
p is equal to 0,

the sum of m, n and p being between 20 and 30, for example being equal to 20, 25 or 30.

According to yet another embodiment, in formula (I) above:
n and p are equal to 0 and
m represents an integer ranging between 20 and 30, for example between 21 and 29 or, for example, equal to 25.

In this embodiment, said alkoxyl chain of the compound of formula (I) is formed exclusively from ethoxyl units OE.

According to another embodiment of the present invention, said thickening polyurethane results from the condensation of at least one compound of formula (I) in which n and p are equal to zero and m represents an integer ranging between 20 and 30.

According to another embodiment of the present invention, said thickening polyurethane results from the condensation of at least one compound of formula (I) in which n and p are equal to zero and m represents an integer ranging between 25 and 30.

Moreover, the polyurethane comprises as constituent b) at least one polyol, which may be a poly(alkylene glycol).

The term “poly(alkylene glycol)” means a polymer of an alkylene glycol derived from an olefinic oxide. The poly(alkylene glycol) chains of constituent b) according to the present invention may, for example, contain a proportion of ethylene-oxy groups, a proportion of propylene-oxy groups and/or a proportion of butylene-oxy groups. The poly(alkylene glycol) chains according to the present invention may, for example, comprise a dominant proportion of ethylene-oxy groups in combination with a secondary proportion of propylene-oxy groups. Specific examples of alkylene glycol polymers comprise: poly(alkylene glycols) with an average molecular weight of 1000 g/mol, 4000 g/mol, 6000 g/mol and 10 000 g/mol; polyethylene polypropylene glycols with a percentage of ethylene oxide of between 20% and 80% by weight and a percentage of propylene oxide of between 20% and 80% by weight.

According to one aspect of the present invention, the polyurethanes result from the condensation especially of a poly(alkylene glycol) which comprises more than 80% by weight of ethylene oxide.

According to one aspect of the present invention, the polyurethanes result from the condensation especially of a poly(alkylene glycol) which is poly(ethylene glycol). It may be, for example, a poly(ethylene glycol) whose molecular mass ranges between 2000 g/mol and 20 000 g/mol, for example between 8000 g/mol and 15 000 g/mol (limits inclusive). By way of example, mention may be made of poly(ethylene glycol) (or PEG) of molecular mass ranging between 10 000 g/mol and 12 000 g/mol (limits inclusive) or that of molecular mass ranging between 5000 g/mol and 7000 g/mol (limits inclusive). By way of example, mention may also be made of poly(ethylene glycol) (or PEG) containing more than 180 OE units, for example 181 or more, or that containing less than 180 OE units, for example 179 or less.

The polyurethane according to the present invention may comprise several different poly(alkylene glycols).

Moreover, the polyurethane comprises as constituent c) at least one polyisocyanate.

The term “polyisocyanate” means a compound which comprises at least 2 isocyanate functional groups —N—C—O.

According to one aspect of the present invention, the polyurethanes result from the condensation especially of a polyisocyanate which is chosen from the group consisting of toluene diisocyanate, toluene diisocyanate dimers, toluene diisocyanate trimers, 1,4-butane diisocyanate, 1,6-hexane diisocyanate, isophorone diisocyanate (IPDI), 1,3-cyclohexane diisocyanate, 1,4-cyclohexane diisocyanate, 4,4′-diisocyanato-dicyclohexylmethane, 1-methyl-2,4-diisocyanatocyclohexane, diphenylmethylene diisocyanate (MDI), for example 2,2′-MDI, 2,4′-MDI, 4,4′-MDI or mixtures thereof, dibenzyl diisocyanate, a mixture of 1-methyl-2,4-diisocyanatocyclohexane and 1-methyl-2,6-diisocyanatocyclohexane, hexamethylene diisocyanate biuret, hexamethylene diisocyanate biuret dimers, hexamethylene diisocyanate biuret trimers, 2,2,4-trimethylhexamethylene diisocyanate and a mixture of at least two of these compounds.

According to another aspect of the present invention, the polyurethanes result from the condensation of at least one polyisocyanate which is isophorone diisocyanate (IPDI).

According to another aspect of the present invention, the polyurethanes result from the condensation of at least one polyisocyanate selected from the group mentioned above with the exclusion of isophorone diisocyanate (IPDI).

According to one embodiment of the present invention, it is excluded for the thickening polyurethane for fabric-softening compositions to result from the condensation:
a) of a compound of alcohol type, as described above,
b) of a poly(ethylene glycol) containing 180 OE units and
c) of isophorone diisocyanate.

According to one aspect of the invention, said thickening polyurethane results from the condensation of:
a) 1% to 29% by weight of at least one compound of formula (I),
b) 70% to 98% by weight of at least one poly(alkylene glycol) and
c) 1% to 29% by weight of at least one polyisocyanate,

the sum of these mass percentages being equal to 100%.

According to another aspect of the invention, said thickening polyurethane results from the condensation of:
a) 3% to 10% by weight of at least one compound of formula (I),
b) 80% to 94% by weight of at least one poly(alkylene glycol) and
c) 3% to 10% by weight of at least one polyisocyanate,

the sum of these mass percentages being equal to 100%.

The manufacture of the polyurethanes, which belong to the family of thickeners of HEUR type, is known to a person skilled in the art, who may refer to the teaching of the documents mentioned previously in the technical background of the present invention.

A subject of the present invention also relates to a process for preparing a polyurethane as described above, said process consisting of a condensation of its various constituents.

Formulation of the HEUR Thickener

The polyurethane according to the invention, which results from the reaction of at least 3 constituents mentioned above, may be in various forms (solid or liquid).

The powder form may be preferred by the formulator in view of its incorporation into a given formulation or on account of certain constraints (available equipment, volumes to be prepared).

However, it may prove preferable to use a polyurethane in liquid form, especially for better dispersibility during addition to aqueous systems and a shorter dissolution time. Most of the commercial associative thickeners are nowadays sold in liquid form.

Thus, the polyurethane according to the invention may also be formulated or co-formulated with other constituents or components, independently of the final composition for the fabric softening.

In particular, the polyurethane according to the invention may be formulated in water.

According to one embodiment, said aqueous formulation according to the invention consists of:
1) 1% to 50% by weight of at least one polyurethane according to the invention, as described above, and
2) 50% to 99% by weight of water,

the sum of these mass percentages being equal to 100%.

According to another embodiment, said aqueous formulation according to the invention consists of:
1) 2% to 25% by weight of at least one polyurethane according to the invention, as described above, and
2) 75% to 98% by weight of water,

the sum of these mass percentages being equal to 100%.

The polyurethane according to the invention may be co-formulated in water, in the presence of at least one surfactant. This surfactant makes it possible to formulate the thickener in the form of a less viscous liquid aqueous solution which can thus be used more easily by the formulator.

Thus, according to one embodiment of the present invention, said aqueous formulation comprises a polyurethane as described above, and also water and a surfactant.

The term “surfactant” or “surfactant agent” means a molecule or a polymer formed from at least one hydrophilic part and at least one hydrophobic part.

The surfactant used in the context of the present invention may be of different nature, for example it may be anionic or nonionic.

This surfactant may be selected from the classes of ionic surfactants (in this case preferably anionic) and/or nonionic and/or mixed surfactants (comprising in the same molecule a nonionic and anionic structure). The preferred surfactant is composed of at least one surfactant selected from the class of nonionic surfactants, optionally in the presence of an anionic surfactant.

Among the anionic surfactants that are suitable for use, mention may be made of the sodium, lithium, potassium, ammonium or magnesium salts derived from alkyl ether sulfates with alkyl ranging from C6 to C12, in linear, iso, oxo, geminal, cyclic or aromatic configuration, or C12 alkyl sulfates, alkyl phosphate esters or dialkyl sulfosuccinates. The anionic surfactants are preferably used with at least one nonionic surfactant.

Examples of mixed surfactants that may be mentioned include alkoxylated alkylphenol sulfonates. The nonionic surfactants may be used alone or in combination with an anionic surfactant. As preferred examples of nonionic surfactants that are suitable for use, mention may be made of: ethoxylated C4-C18 alcohols (2 to 15 OE), ethoxylated C4-C18 Guerbet alcohols (2 to 40 OE), ethoxylated C10-C18 monobranched alcohols (2 to 40 OE), C18 sorbitol esters, ethoxylated sorbitol esters (2 to 20 OE units), ethoxylated C4-C18 acids (less than 15 OE), ethoxylated castor oil (30 to 40 OE), ethoxylated hydrogenated castor oil (7 to 60 OE), esters, for instance glycerol palmitate, glycerol stearate, ethylene glycol stearate, diethylene glycol stearate, propylene glycol stearate, polyethylene glycol 200 stearate and ethoxylated C18 esters (2 to 15 OE). The hydrophobic chains may correspond to linear, iso, oxo, cyclic or aromatic structures.

According to one embodiment, the polyurethane of the present invention is formulated in the presence of at least one nonionic surfactant, optionally combined with at least one anionic surfactant, in a total weight content ranging from 5% to 30% by weight, for example from 8% to 20% by weight or from 10% to 17% by weight. In this case, the weight ratio between the two surfactants may range, for example, between 25/75 and 75/25.

According to one embodiment of the present invention, the polyurethane of the present invention is formulated in the presence of more than two surfactants, for example three or four.

According to one embodiment, said aqueous formulation according to the invention consists of:
1) 2% to 50% by weight of at least one polyurethane according to the invention, as described above, preferably 5% to 30% by weight,
2) 5% to 40% by weight of at least one surfactant, preferably 8% to 30% by weight, and
3) 10% to 93% by weight of water, preferably 40% to 85% by weight,

the sum of these mass percentages being equal to 100%.

The polyurethane according to the invention may be formulated in a water-miscible solvent. The main reason for adding an organic cosolvent is to lower the viscosity of this polyurethane in water, so as to facilitate the handling. The polyurethane is formulated, for example, with one or more polar solvents belonging especially to the group formed by water, methanol, ethanol, propanol, isopropanol, butanols, acetone, tetrahydrofuran, or mixtures thereof.

A particular example of a water-miscible organic solvent is diethylene glycol monobutyl ether (also known under the name Butyl Carbitol™) or ethylene or propylene glycol monobutyl ether.

The viscosity of the polyurethane in unmodified form, before its incorporation into a fabric-softening composition, is preferentially less than 10 000 mPa.s at 25° C. and at 100 rpm, so that it is easier to pour from the storage container and more rapidly incorporated into the composition to be thickened at room temperature. The water-miscible solvent chosen for such commercial compositions has hitherto exclusively been an organic solvent.

According to one aspect of the invention, the HEUR thickening formulation also comprises at least one additive selected from the group formed from a biocide, a pH regulator, an antifoam agent, an encapsulating agent, and mixtures thereof.

The term “biocide” means a chemical substance intended to destroy, repel or render inoffensive harmful organisms, to prevent the action thereof or to combat them in any other way, via a chemical or biological action.

The term “pH regulating agent” means an agent that can significantly vary the pH of the formulation. The pH regulating agent may increase the pH, this being the case for bases such as NaOH. Alternatively, the pH regulating agent may decrease the pH, this being the case for acids. By way of example, use is made of one or more neutralizing agent(s) having a monovalent neutralizing function and/or a divalent or polyvalent neutralizing function, for instance:

for the monovalent function, those chosen from the group formed by alkaline cations, in particular sodium, potassium, lithium, ammonium or primary, secondary or tertiary aliphatic and/or cyclic amines, for instance stearylamine, ethanolamines (mono-, di-, triethanolamine), mono- and diethylamine, cyclohexylamine, methylcyclohexylamine and

for the divalent/polyvalent function, those chosen from the group formed by divalent alkaline-earth metal cations, in particular magnesium, calcium, zinc, and also by trivalent cations, in particular including aluminum, or alternatively by certain cations of higher valency.

The term “antifoam agent” means a substance or formulation intended to destroy air bubbles within a homogeneous or heterogeneous liquid medium (or at its surface) or to prevent their formation.

The term “encapsulating agent” means an agent which creates a hydrophobic environment, for example a solvation cage. Mention is made in particular, as encapsulating agent, of cyclodextrin.

According to one embodiment, said aqueous formulation according to the invention consists of:
1) 2% to 50% by weight of at least one polyurethane according to the invention, as described above, preferably 5% to 30% by weight,
2) 5% to 40% by weight of at least one surfactant, preferably 8% to 30% by weight,
3) 10% to 93% by weight of water, preferably 40% to 85% by weight, and
4) 0% to 5% by weight of at least one other additive chosen from the group consisting of a biocide, a pH regulator, an antifoam agent, an encapsulating agent, and mixtures thereof, preferably 0.5% to 4% by weight,

the sum of these mass percentages being equal to 100%.

Fabric-Softening Composition

The present invention also relates to a fabric-softening composition comprising a thickening polyurethane according to the invention, as described above, and also a cationic fabric softening agent.

The cationic agent giving the softening nature is dispersed in the aqueous composition.

Such fabric-softening compositions are intended, for example, to be used in the rinsing cycle of a washing or laundering process.

The use of thickener in the softening composition according to the invention makes it possible to facilitate the dosing during use. Moreover, consumers generally consider that the efficiency of the compositions is associated with their viscosity. Thus, it is commercially advantageous for the softening composition according to the invention to comprise a thickener.

According to one embodiment of the present invention, the viscosity of said fabric-softening composition, as measured with a Brookfield RVT viscometer at a temperature of 25° C. at a spin speed of 20 rpm and after 24 hours of storage at 25° C. in the non-stirred flask, is greater than 300 mPa.s, for example greater than 400 mPa.s or 500 mPa.s.

The present invention also relates to fabric-softening compositions which disperse easily in water at the time of use, in particular in washing machines equipped with automatic dispensing mechanisms.

According to one embodiment of the present invention, the fabric-softening compositions have a stable thickness/viscosity over time, for a duration of at least 7 days, preferably for a duration of at least 14 days. The term “stable” means that the viscosity as measured with a Brookfield RVT viscometer, after 7 days of storage (storage temperature: 25° C.), preferably after 14 days of storage, in the non-stirred flask, at a temperature of 25° C. at a spin speed of 20 rpm, is at least equal to 50% of the viscosity measured according to the same protocol after 24 hours of storage in the non-stirred flask, at a temperature of 25° C.

Thus, according to this embodiment, the fabric-softening composition, comprising:

a cationic fabric softening agent and

a thickening polyurethane resulting from the condensation:
a) of at least one compound of formula (I):

R—[(OE)ₘ-(OP)ₙ—(OB)ₚ]—OH (I)
in which:
R is a saturated or unsaturated, linear or branched carbon chain containing from 17 to 24 carbon atoms,
[(OE)ₘ-(OP)ₙ—(OB)ₚ] represents an alkoxyl chain formed from alternating or statistical alkoxyl units, distributed in blocks, chosen from ethoxyl units OE, propoxyl units OP and butoxyl units OB and
m, n and p represent, independently of each other, 0 or an integer ranging between 1 and 30, the sum of m, n and p being between 20 and 30,
b) of at least one polyol, for example of at least one poly(alkylene glycol) and
c) of at least one polyisocyanate,

and having a rheological profile such that:

its viscosity μ₁, as measured with a Brookfield RVT viscometer, after 24 hours of storage (at 25° C.), in the non-stirred flask, at a temperature of 25° C. at a spin speed of 20 rpm, is greater than 300 mPa.s, for example greater than 400 mPa.s or 500 mPa.s and

its viscosity μ₂, as measured with a Brookfield RVT viscometer, after 7 days of storage (at 25° C.), for example after 14 days of storage, in the non-stirred flask, at a temperature of 25° C. at a spin speed of 20 rpm, is greater than 50% of the value of μ₁, for example greater than 60% or 70% of the value of μ₁.

The cationic fabric softening agent is chosen so as to give the treated fabrics softness and swelling during rinsing, after washing. It is also capable of giving antistatic properties. Without wishing to be bound by the following theory, concerning the mechanism of action of the cationic fabric softening agents, it is probable that the fixing, via the cationic unit, of fatty chains to the surface of the fibers lubricates them and allows them to move relative to each other, thus reducing the impression of stiffness associated with untreated laundry.

According to the present invention, the cationic fabric softening agent may especially be a compound comprising a cationic nitrogen atom N⁺, at least one fatty chain, for example a carbon chain of 4 to 36 atoms, and at least one ester function. The fatty chain may comprise atoms other than carbon atoms. For example, it may comprise silica atoms Si. The cationic nitrogen atom N⁺ may be linked to the fatty chains via ester functions, for example via:
—(CH₂)ₙ—O—C(═O) chains, in which n ranges between 0 and 5 and/or
═C(—O—C(═O)—(CH₂)ₙ—CH₃)₂ chains in which n ranges between 4 and 36 carbon atoms.

It may be, for example, a compound of “esterquat” (EQ) type. Various types of quaternary ammonium compounds containing an ester may be used in the context of the present invention, including triester-quaternary ammonium compounds (TEQ) and diester-quaternary ammonium compounds (DEQ). These compounds may also comprise a mixture of mono-(I), di-(II) and tri-(III) ester components.

According to one embodiment of the present invention, said cationic fabric softening agent is a triester-quaternary ammonium compound (TEQ) and/or a diester-quaternary ammonium compound (DEQ).

Compounds of esterquat type are commercially available. They are occasionally known, equivalently, as cationic surfactants.

The compounds of esterquat type according to the invention may be formed, for example, from two or three ester radicals substituted with alkyl or alkenyl groups, according to the definition given previously.

The cationic fabric softening agent is chosen, for example, in a non-restrictive manner, from the list of products below:

methyl bis[ethyl (tallowate)]-2-hydroxyethyl ammonium methyl sulfate (Rewoquat™WE 18, Rewoquat™WE 15, Rewoquat™WE 38, Evonik company), origin: animal tallow,

di-palm carboxyethyl hydroxyethyl methyl ammonium methosulfate (Rewoquat™WE HV, Evonik company), origin: palm oil,

N,N′-di(alkylcarboxyethyl)-N-hydroxyethyl-N-methylammonium methyl sulfate (Rewoquat™WE 45, Evonik company),

C10-20 and C16-18 unsaturated fatty acids, mono-, di- and triesters (Hisofter™ HK 9061, Hisofter™ MEQ 710, Hisofter™ NEQ 70, Ohsung Chem company),

commercial product Stepantex™ DC 90 (Stepan company), origin: rapeseed oil,

C16-18 and C18 unsaturated fatty acids (Stepantex™ GA 90, Stepantex PA 88E, Stepantex™ SP 90, Stepan company), origin: partially hydrogenated palm oil,

commercial product Stepantex™VA or Stepantex™ VL 90A (Stepan company), origin: partially hydrogenated tallow,

methyl bis[ethyl (tallowate)]-2-hydroxyethyl ammonium methyl sulfate, (Stepantex™VK90, Stepantex™VT 90, Stepan company), origin: partially hydrogenated tallow,

C16-18 and C18 unsaturated fatty acids (Stepantex™ VL 85G, Stepantex™ VL 88E, Stepan company), origin: partially hydrogenated tallow,

commercial product Stepantex™ VR 90 (Stepan company), origin: tallow,

di(tallowamidoethyl) hydroxyethylmethylammoniummethyl sulfate (Incrosoft™ T90, Croda company), origin: tallow,

di(oleyl-carboxyethyl), or hydroxyethyl methyl ammonium methylsulfate, (Incrosoft™ TSO 90, Croda company),

C16-C18 dialkyl chloride, quaternary ammonium dimethyl ester chloride (Armosoft™ DEQ, Akzo company), origin: tallow,

N,N-di(canola-oyloxyethyl)-N,N-dimethylammonium chloride (Adogen™ CDMC, Degussa company), origin: canola oil,

tallowoylethyl hydroxyethyl hydroxyethylmonium methosulfate and ditallowoylethyl hydroxyethylmonium methosulfate (Britesoft™ EQ 90, Chemelco company),

commercial product Tetranyl L1/90S ™ or Tetranyl ™ AT1 (Kao company), origin: animal tallow,

hydroxyethylmonium methosulfate (Tetranyl™CO 40 and Tetranyl™ AO-1, Kao),

commercial product Tetranyl L6/90™ (Kao company), origin: palm oil,

hydroxyethyl methyl ammonium methylsulfate (Elotant™ EQ 200E, Elotant™ EQ 100, LG Household company),

commercial product Elotant™ EQ 400 or Elotant™ EQ 500 (LG Household company) and

commercial product Arquat™ 2HT-75 (Akzo company).

According to one aspect of the invention, the aqueous composition also comprises at least one additive selected from the group consisting of a fragrance, a biocide, a pH regulator, an antifoam agent, a coloring agent, an antistatic agent, an opacifying agent, a bleaching agent (for example a peracid), an enzymatic agent and an optical brightener. The aqueous composition according to the present invention may comprise a mixture of two or more of these additives.

According to one aspect of the present invention, the aqueous composition comprises from 0.02% to 5% by weight of active material of said polyurethane.

According to another aspect of the present invention, the aqueous composition comprises from 0.05% to 2% by weight of active material of said polyurethane.

The term “weight of active material” means the dry weight of polyurethane according to the invention, independently of the other ingredients of the composition.

According to one aspect of the present invention, the aqueous composition comprises from 1% to 30% by weight of cationic fabric softening agent, preferably from 2% to 12% by weight or from 2.5% to 10% by dry weight.

Process for Preparing the Softening Composition

The softening composition is prepared according to the standard processes, known to those skilled in the art.

The cationic fabric softening agent is generally in a solid form at room temperature, and so it is necessary to melt it before incorporating it into an aqueous composition. Thus, this agent is heated to a temperature at least higher than its melting point.

According to one embodiment, the cationic fabric softening agent is heated to a temperature of between 45° C. and 70° C., for example between 50° C. and 65° C., before being incorporated into the rest of the formulation.

According to one embodiment of the process for preparing the softening composition, the cationic fabric softening agent is incorporated in liquid form, in the molten state, into a volume of water, for example demineralized water, preheated to a temperature at least above the melting point of the cationic fabric softening agent. Thus, according to this embodiment of the process for preparing the softening composition, said volume of water, for example demineralized water, is heated to a temperature above 45° C., for example above 50° C., for example to 70° C.±2° C. The incorporation of the cationic agent in liquid form, in the molten state, into said volume of water preferably takes place with stirring.

After incorporation of the fabric softening agent into the given amount of water, the solution is allowed to cool to a temperature below the melting point of the cationic fabric softening agent.

According to one embodiment, the solution is allowed to cool to a temperature below 40° C., for example below 35° C., for example a temperature of 30° C.±2° C. The additive(s) selected from the group consisting of a fragrance, a biocide, a pH regulator, an antifoam agent, a coloring agent, an antistatic agent, an opacifying agent, a bleaching agent (for example a peracid), an enzymatic agent and an optical brightener are then added, if necessary.

Finally, the thickening polyurethane according to the present invention, as described previously, is added. The addition of the polyurethane may take place with stirring or using any means allowing homogeneous incorporation of said polyurethane into the formulation.

Use

According to one aspect of the present invention, said thickening polyurethane resulting from the condensation:
a) of at least one compound of formula (I):

R—[(OE)ₘ-(OP)ₙ—(OB)ₚ]—OH (I)
in which:
R is a saturated or unsaturated, linear or branched carbon chain, containing from 17 to 24 carbon atoms,
[(OE)ₘ-(OP)ₙ—(OB)ₚ] represents an alkoxyl chain formed from alternating or statistical alkoxyl units, distributed in blocks, chosen from ethoxyl units OE, propoxyl units OP and butoxyl units OB and
m, n and p represent, independently of each other, 0 or an integer ranging between 1 and 30, the sum of m, n and p being between 20 and 30,
b) of at least one polyol, for example of at least one poly(alkylene glycol) and
c) of at least one polyisocyanate,

is used for thickening a softening composition containing a cationic fabric softening agent.

Said polyurethane may especially be used for thickening a fabric-softening composition to a viscosity μᵢ, as measured with a Brookfield RVT viscometer, after 24 hours of storage at 25° C., in the non-stirred flask, at a temperature of 25° C. at a spin speed of 20 rpm, greater than 300 mPa.s, for example greater than 400 mPa.s or 500 mPa.s.

The viscosity of the fabric-softening composition is dependent on the concentration of polyurethane thickeners. The formulator knows how to adapt this concentration to obtain the expected viscosity. The thickeners according to the invention make it possible, at equal doses, to obtain significantly improved thickening when compared with the polyurethane thickeners of the prior art.

Said polyurethane may especially be used for thickening a fabric-softening composition to:

a viscosity μ₁, as mentioned above, and

a viscosity μ₂, as measured with a Brookfield RVT viscometer, after 7 days of storage, for example after 14 days of storage, in the non-stirred flask, at a temperature of 25° C. at a spin speed of 20 rpm, greater than 50% of the value of μ₁, for example greater than 60% or 70% of the value of μ₁.

The examples that follow allow the present invention to be better understood, without limiting its scope.

### EXAMPLES

The Brookfield viscosity of the fabric-softening compositions is measured using a Brookfield RVT viscometer, at a temperature of 25° C. at a spin speed of 20 rpm (example 1) or 10 rpm (example 2) with the appropriate spindle and after 24 hours of storage in the non-stirred flask and stored for this time at 25° C. The reading is taken after 1 minute of rotation. A Brookfield viscosity measurement written as μ_{Bk20} (mPa.s) is obtained. The Brookfield viscosities at T=7 days and at T=14 days are also measured.

### Example 1

This example illustrates the use of thickening polyurethanes according to the invention in a fabric-softening composition, comprising a cationic agent of esterquat type. All of the raw materials are commercially available.

Process for Preparing the Fabric-Softening Composition 55.6 g of esterquat cationic agent Stepantex™ VT90 (90%) from the company Stepan are melted at 60° C.

944.4 g of demineralized water are heated to 70° C. The water is stirred and the cationic agent is poured into the hot water. The mixture is allowed to cool to 30° C. with continued stirring.

5 g of fragrance, in this instance essential oil of lavender (Lavendula burnatii) and 0.7 g of violet coloring agent having a 1% solids content (INCI name: pigment violet 23) are added.

1005.5 g of softening base are obtained, to which is added the thickener to be tested.

More precisely, polyurethanes according to the invention are used (tests 1-4 and 1-5), using a compound of formula (I). In parallel, this example also illustrates polyurethanes outside the invention (tests 1-1, 1-2, 1-3 and 1-6).

Test 1-1 (Outside the Invention)

Said polyurethane results from the condensation of, expressed as weight %s relative to the total weight of the polyurethane:

20.1% by weight of an alcohol of formula: 2-hexyl-2-decanyl(OE)₂₅OH (16 carbon atoms, branched chain),

74.9% by weight of PEG 10 000 and

5.0% by weight of isophorone diisocyanate (IPDI).

Test 1-2 (Outside the Invention)

Said polyurethane results from the condensation of, expressed as weight %s relative to the total weight of the polyurethane:

26.1% by weight of an alcohol of formula:

R—[(OE)ₘ-(OP)ₙ—(OB)ₚ]—OH (I)

in which:
m=36, n=0 and p=0 and
R is a branched C20:0 chain containing 20 carbon atoms,

69.3% by weight of PEG 10 000 and

4.6% by weight of isophorone diisocyanate (IPDI).

Test 1-3 (Outside the Invention)

Said polyurethane results from the condensation of, expressed as weight %s relative to the total weight of the polyurethane:

4.4% by weight of an alcohol of formula:

R—[(OE)ₘ-(OP)ₙ—(OB)ₚ]—OH (I)

in which:
m=0, n=0 and p=0 and
R is a linear C12:0 chain containing 12 carbon atoms,

90.4% by weight of PEG 10 000 and

5.2% by weight of isophorone diisocyanate (IPDI).

Test 1-4 (According to the Invention)

Said polyurethane results from the condensation of, expressed as weight %s relative to the total weight of the polyurethane:

17.6% by weight of a compound of formula (I):

R—[(OE)ₘ-(OP)ₙ—(OB)ₚ]—OH (I)

in which:
m=20, n=0 and p=0 and
R is a linear C18:1 chain containing 18 carbon atoms bearing an unsaturation,

76.6% by weight of PEG 10 000 and

5.8% by weight of isophorone diisocyanate (IPDI).

Test 1-5 (According to the Invention)

Said polyurethane results from the condensation of, expressed as weight %s relative to the total weight of the polyurethane:

21% by weight of a compound of formula (I):

R—[(OE)ₘ-(OP)ₙ—(OB)ₚ]—OH (I)

in which:
m=25, n=0 and p=0 and
R is a linear C22:0 chain containing 22 carbon atoms,

73.5% by weight of PEG 10 000 and

5.5% by weight of isophorone diisocyanate (IPDI).

Test 1-6 (Outside the Invention)

The illustrated polyurethane results from the condensation of two different alcohols of formula (I). More precisely, said polyurethane results from the condensation of, expressed as weight %s relative to the total weight of the polyurethane:

8.9% by weight of a compound of formula (I):

R—[(OE)ₘ-(OP)ₙ—(OB)ₚ]—OH (I)

in which:
m=23, n=0 and p=0 and
R is a linear C12^{.}0 chain containing 12 carbon atoms,

11.6% by weight of a compound of formula (I)' .

R—[(OE)ₘ-(OP)ₙ—(OB)ₚ]—OH (I)

in which:
m 25, n =0 and p =0 and
R is a branched C32:0 chain containing 32 carbon atoms,

73.9% by weight of PEG 10 000 and

5.6% by weight of isophorone diisocyanate (IPDI).

The polyurethanes are formulated in water in the presence of a surfactant, which is Mergital® D8. The PU/surfactant/water ratios are 17.5/9.5/73.

Next, they are added to the fabric-softening composition in mass ratios indicated in table 1 below.

All the results are collated in table 1.

For each of the tests, the viscosities μ_{Bk20} were determined, according to the methods described above at T=24 hours, at T=7 days and at T=14 days, at room temperature.

TABLE 1

| | 1-1 | 1-2 | 1-3 | 1-4 | 1-5 | 1-6 |
|---|---|---|---|---|---|---|
| Test | OInv | OInv | OInv | INV | INV | OInv |
| Mass of softening composition (g): | 100 | 100 | 100 | 100 | 100 | 100 |
| Mass of pU thickener to be tested (g): | 0.307 | 0.308 | 0.307 | 0.301 | 0.310 | 0.308 |
| μ_{Bk20} at T = 24 h (mPa · s) - μ₁ | 125 | 245 | 170 | 465 | 665 | 205 |
| μ_{Bk20} at T = 7 days (mPa · s) - μ₂ | 70 | 135 | 105 | 305 | 520 | 190 |
| μ₂/μ₁ (%) at T = 7 days | 56 | 55 | 62 | 65.6 | 78 | 92.7 |
| μ_{Bk20} at T = 14 days (mPa · s) - μ₂ | 60 | 115 | | 235 | 360 | |
| μ₂/μ₁ (%) at T = 14 days | 48 | 47 | | 50.5 | 54 | |

OInv: Outside invention

INV: INVenti on

Significantly improved thickening is found in the formulations using a thickening polyurethane according to tests 1-4 and 1-5 (according to the invention), compared with those of tests 1-1 to 1-3 and 1-6 (outside the invention).

Moreover, the thickening polyurethanes according to the invention allow stable thickening at 7 days and at 14 days: the ratio μ₂/μ₁ (%) is greater than 50% for all of the tests performed with a thickening polyurethane corresponding to the criteria of the present invention, which is not the case for the thickeners outside the invention.

### Example 2

This example illustrates the use of a thickening polyurethane according to the invention in a fabric-softening composition, comprising a cationic agent of quat type. All of the raw materials are commercially available.

Process for Preparing the Fabric-Softening Composition 50 g of cationic agent Arquat™ 2HT-75 (75%) from the company Akzo are melted at 60° C.

950 g of demineralized water are heated to 70° C. The water is stirred and the cationic agent is poured into the hot water. The mixture is allowed to cool to 30° C. with continued stirring.

1000 g of softening composition are obtained, to which is added the thickener to be tested.

Test 2-1 (According to the Invention)

Said polyurethane results from the condensation of, expressed as weight %s relative to the total weight of the polyurethane:

21% by weight of a compound of formula (I):

R—[(OE)ₘ-(OP)ₙ—(OB)ₚ]—OH (I)

in which:
m=25, n=0 and p=0 and
R is a linear C22:0 chain containing 22 carbon atoms,

73.5% by weight of PEG 10 000 and

5.5% by weight of isophorone diisocyanate (IPDI).

The polyurethane is formulated in water in the presence of a surfactant, which is Mergital® D8. The PU/surfactant/water ratios are 17.5/9.5/73.

Next, it is added to the fabric-softening composition in mass ratios indicated in table 2 below.

All the results are collated in table 2.

The viscosities μ_{Bk10} were determined, according to the method described above at T=0, before adding the polyurethane, at T=24 h and at T=7 days, at room temperature.

TABLE 2

| | 2-1 |
|---|---|
| Test | Invention |
| Mass of softening composition (g): | 100 |
| μ_{Bk10} before adding pU (mPa · s) | 1510 |
| Mass of pU thickener to be tested (g): | 0.299 |
| μ_{Bk10} at T = 24 h (mPa · s) - μ₁ | 3220 |
| μ_{Bk10} at T = 7 days (mPa · s) - μ₂ | 3020 |
| μ₂/μ₁ (%) at T = 7 days | 93.8 |

1. A fabric-softening composition, comprising:
a cationic fabric softening agent and
a polyurethane thickener resulting from condensation:
a) of at least one compound of formula (I):
R—[(OE)ₘ-(OP)ₙ—(OB)ₚ]—OH (I)
in which:
R is a saturated or unsaturated, linear or branched carbon chain, containing from 17 to 24 carbon atoms,
[(OE)ₘ-(OP)ₙ—(OB)ₚ] represents an alkoxyl chain formed from alternating or statistical alkoxyl units, distributed in blocks, chosen from ethoxyl units OE, propoxyl units OP and butoxyl units OB and
m, n and p represent, independently of each other, 0 or an integer ranging between 1 and 30, the sum of m, n and p being between 20 and 30,
b) of at least one polyol, for example of at least one poly(alkylene glycol) and
c) of at least one polyisocyanate.

2. The composition as claimed in claim 1, in which said polyurethane thickener results from condensation of at least one compound of formula (1) in which R is a linear or branched carbon chain bearing at least one unsaturation, containing from 17 to 24 carbon atoms.

3. The composition as claimed in claim 1, in which said thickening polyurethane results from the condensation of at least one compound of formula (I) in which n and p are equal to zero and m represents an integer ranging between 20 and 30.

4. The composition as claimed in claim 1, in which said thickening polyurethane results from the condensation of at least one compound of formula (I) in which n and p are equal to zero and m represents an integer ranging between 25 and 30.

5. The composition as claimed in claim 1, in which said thickening polyurethane results from the condensation of:
a) 1% to 29% by weight of at least one compound of formula (I),
b) 70% to 98% by weight of at least one poly(alkylene glycol) and
c) 1% to 29% by weight of at least one polyisocyanate,
the sum of these mass percentages being equal to 100%.

6. The composition as claimed in claim 5, in which said thickening polyurethane results from the condensation of:
a) 3% to 10% by weight of at least one compound of formula (I),
b) 80% to 94% by weight of at least one poly(alkylene glycol) and
c) 3% to 10% by weight of at least one polyisocyanate,
the sum of these mass percentages being equal to 100%.

7. The composition as claimed in claim 1, in which said cationic fabric softening agent is a triester-quaternary ammonium compound (TEQ) and/or a di ester-quaternary ammonium compound (DEQ).

8. The composition as claimed in claim 1, having a viscosity of greater than 300 mPa.s, as measured with a Brookfield RVT viscometer, after 24 hours of storage in the non-stirred flask, at a temperature of 25° C. at a spin speed of 20 rpm.

9. The composition as claimed in claim 1, having a rheological profile such that:
its viscosity μ₁, as measured with a Brookfield RVT viscometer, after 24 hours of storage, in the non-stirred flask, at a temperature of 25° C. at a spin speed of 20 rpm, is greater than 300 mPa.s and
its viscosity μ₂, as measured with a Brookfield RVT viscometer, after 7 days of storage, for example after 14 days of storage, in the non-stirred flask, at a temperature of 25° C. at a spin speed of 20 rpm, is greater than 50% of the value of μ₁.

10. The composition as claimed in claim 1, comprising:
from 0.02% to 5% by weight of active material of said polyurethane, and
from 1% to 30% by weight of cationic fabric softening agent.

11. The composition as claimed in claim 1, further comprising at least one additive selected from the group consisting of a fragrance, a biocide, a pH regulator, an antifoam agent, a coloring agent, an antistatic agent, an opacifying agent, a bleaching agent, an enzymatic agent and an optical brightener.

12. A method for thickening a softening composition containing a cationic fabric softening agent comprising incorporating into said softening comprising thickening polyurethane resulting from the condensation:
a) of at least one compound of formula (I):
R—[(OE)ₘ-(OP)ₙ—(OB)ₚ]—OH (I)
in which:
R is a saturated or unsaturated, linear or branched carbon chain, containing from 17 to 24 carbon atoms,
[(OE)ₘ-(OP)ₙ—(OB)ₚ] represents an alkoxyl chain formed from alternating or statistical alkoxyl units, distributed in blocks, chosen from ethoxyl units OE, propoxyl units OP and butoxyl units OB and
m, n and p represent, independently of each other, 0 or an integer ranging between 1 and 30, the sum of m, n and p being between 20 and 30,
b) of at least one polyol, for example of at least one poly(alkylene glycol) and
c) of at least one polyisocyanate.
